(19) United States
(12) Patent Application Publication
(10) Pub. No.: US 2006/0197992 A1
(43) Pub. Date: Sep. 7, 2006

(54) Stochastic screens for rendering devices with high-addressability

(75) Inventor: Shen-ge Wang, Fairfield, NY (US)

Correspondence Address: ORTIZ & LOPEZ, PLLC;Patent Attorneys, P.O. Box 4484, Albuquerque, NM, 87196-4484, US

(73) Assignee: Xerox Corporation

(21) Appl. No.: 11/070,078

(22) Filed: Mar. 2, 2005

(51) Int. Cl. H04N 1/405

(52) U.S. Cl. 358/3.19

(57) ABSTRACT

A stochastic dot-growth sequence for a stochastic screen can be initially compiled into two sections, including at least a first section and at least a section. Additional sections can be provided as necessary (e.g., third, fourth, etc.). The first section provides, for example, from 0% to 50% area coverage, while the section can provide an area coverage of between 50% and 100% depending upon design considerations. For the first section, the sequential values can be utilized to fill corresponding pixels of a “high addressability” stochastic screen. A similar process is then applied to the second section and additional sections, if necessary. In this manner, non-printable sub pixel issues can be avoided while providing improved color stability, smooth transitions, less noise and improved sharpness during rendering via a high addressability stochastic screen.

### TECHNICAL FIELD

Embodiments are generally related to data-processing methods and systems. Embodiments are also related to rendering devices, such as printers, scanners, multi-function devices, photocopy machines, and the like. Embodiments are also related to stochastic screens for rendering devices, particularly those involved in the digital reproduction of color documents.

### BACKGROUND

Color in documents is the result of a combination of a limited set of colors over a small area, in densities selected to integrate to a desired color response. This is accomplished in many printing devices by reproducing separations of the image, where each separation provides varying density of a single primary color. When combined together with other separations, the result is a full color image.

In the digital reproduction of documents, a separation is conveniently represented as a monochromatic bitmap, which may be described as an electronic image with discrete signals (hereinafter, pixels) defined by position and density. In such a system, density is described as one level in a number of possible states or levels. When more than two levels of density are used in the description of the image, the levels are often termed “gray”, indicating that they vary between a maximum and minimum, and without reference to their actual color. Most printing systems have the ability to reproduce an image with a small number of levels, most commonly two, although other numbers are possible.

Common input devices including document scanners, digital cameras and the computer imagery generators, however, are capable of describing an image with a substantially larger number of gray levels, with 256 levels a commonly selected number, although larger and smaller levels are possible. It is required that an image initially described at a large set of levels also be describable at a smaller set of levels, in a manner, which captures the intent of the user. In digital reproduction of color documents this means that each of the color separations is reduced from the input number of levels to a smaller output number of levels. The multiple color separations are combined together at printing to yield the final color print. Commonly, color documents are formed using cyan, magenta and yellow colorants or cyan, magenta, yellow and black colorants. A larger number or alternative colorants may also be used.

Printers typically provide a limited number of output possibilities, and are commonly binary, i.e., they produce either a spot or no spot at a given location (although multilevel printers beyond binary are known). Thus, given an image or a separation in a color image having perhaps 256 possible density levels, a set of binary printer signals must be produced representing the contone effect. In such arrangements, over a given area in the separation having a number of contone pixels therein, each pixel value in an array of contone pixels within the area can be compared to one of a set of preselected thresholds.

The effect of such an arrangement is that, for an area where the image is a contone, some of the thresholds will be exceeded, i.e. the image value at that specific location is larger than the value of the threshold for that same location, while others are not. In the binary case, the pixels or cell elements for which the thresholds are exceeded might be printed as black or some color, while the remaining elements are allowed to remain white or uncolored, dependent on the actual physical quantity described by the data. The described halftoning or dithering method produces an output pattern that is periodic or quasiperiodic in the spatial coordinates.

Dithering creates problems in color document reproduction where the repeating pattern of a screen through the image, when superposed over similar repeating patterns in multiple separations, can cause moire or other artifacts, particularly in printing systems with less than ideal registration between separations. One of the advantages of stochastic, or non-periodic screening over periodic screening is the suppression of moiré.

Other techniques include a method for generating a non-periodic halftone distribution by determining areas of constant or nearly constant input density and by distributing a pre-calculated number of print dots inside each area based on a random or pseudo random number and some spatial constraints. Another conventional stochastic screening algorithm in which the print/no-print decision is based on a recursive subdivision of the print field maintaining average density over the larger print field.

An idealized stochastic screen characterized by all of the predominant color dots (black or white) uniformly distributed is taught in U.S. Pat. No. 5,673,121, which issued to Shen-ge Wang on Sep. 30, 1997 and is incorporated herein by reference.

A direct application of standard stochastic screens to the highest resolutions in both directions has two major drawbacks. First, the halftone textures are non-isotropic. Second, and more importantly, the individual dots generated are too small to yield the expected image quality. For rendering devices such as inkjet printers, for example, individual drops are usually much larger than the sizes defined by the highest resolutions of printers. Two adjacent drops too close to each other not only are not resolvable, but also complicate the ink-limit problem. For some rendering devices, individual dots that are too small can increase the noise of the halftone outputs and reduce the color stability. Therefore, many conventional rendering devices utilize stochastic screens at relatively lower resolutions, even if they possess higher resolution or high addressability in one of the two dimensions.

The use of high addressability rendering techniques and devices in association-with stochastic screens, however, often introduces non-isotropic halftone textures and can also increase color instability and noise. Based on the foregoing, it is believed that an improved stochastic screening methodology can produce higher image quality and improved color stability.

### BRIEF SUMMARY

It is a feature of the present invention to provide improved data-processing methods and systems.

It is also a feature of the present invention to provide improved methods and systems for rendering data and graphics.

It is also a feature of the present invention to provide for improved stochastic screens for high-addressability rendering devices.

Aspects of the present invention relate to methods and systems for providing stochastic screens for rendering devices with high-addressability. A stochastic dot-growth sequence for a stochastic screen can be initially compiled into two sections, including at least a first section and at least a section. Additional sections can be compiled as necessary (e.g., third, fourth, etc.). The first section provides, for example, from 0% to 50% area coverage, while the section can provide area coverage of between 50% and 100% depending upon design considerations. For the first section, the sequential values can be utilized to fill corresponding pixels of a “high addressability” stochastic screen. A similar process is then applied to the second section and additional sections, if necessary.

The stochastic dot-growth sequence can therefore be utilized to successively fill a “high addressability” stochastic screen with a first minimum subpixel. Thereafter, an upper range of the high addressability stochastic screen can be filled with a plurality of varying sequential subpixels, thereby avoiding non-printable subpixel issues and providing improved color stability, smooth transitions, less noise and improved sharpness during rendering via the high addressability stochastic screen.

A standard isotropic stochastic screen can be implemented as, for example, a 1:1 isotropic stochastic screen. The stochastic dot-growth sequence can be initially compiled for the standard isotropic stochastic screen up to 50% coverage thereof. The high addressability stochastic screen itself is generally associated with a rendering device, such as an ink jet printer, which can be implemented as a high-addressability printer.

In general, a stochastic dot-growth sequence can be determined for a normal 1:1 isotropic stochastic screen up to 50% area coverage. Thereafter, the same sequenced can be utilized to successively fill the high addressability screen with a minimum subpixel (e.g., 2/8^{th} of a full pixel when it is known that ⅛ will not print), and then larger subpixels until the 1:1 screen is 50% complete. The upper range is similarly filled with possibly different sequential subpixels. The problem of non-printable subpixels is then avoided.

The methods and systems disclosed herein therefore avoid the non-isotropic and noisy patterns than can result from direct stochastic designs at high addressability. Advantages of such methods and systems include improved color stability, smoother transitions, less noise, and improved sharpness.

### BRIEF DESCRIPTION OF THE DRAWINGS

The particular values and configurations discussed in these non-limiting examples can be varied and are cited merely to illustrate one or more embodiments and are not intended to limit the scope thereof.

FIGS. 1 and 2 represent a halftoning system that can be implemented in accordance with one possible embodiment;

FIG. 3 illustrates the improvement of quality Q over the iterative process of the embodiments;

FIG. 4 illustrates a flow chart of process for finding the local quality measurement;

FIG. 5 illustrates the measurement of Rᵢⱼ;

FIG. 6 illustrates the global quality measurement used to derive an optimized threshold screen;

FIGS. 7A and 7B illustrates a table indicative of a stochastic sequence in the context of an M×N array;

FIG. 8 illustrates an example of an output binary pattern with an input value of 4 in accordance with one illustrative embodiment;

FIG. 9 illustrates a direct application of the sample screen to a high-addressability print in order to yield a binary output composed of output patterns in accordance with one embodiment;

FIGS. 10A and 10B illustrate a table and corresponding binary output patterns, in accordance with one embodiment;

FIGS. 11A and 11B illustrate a table and corresponding binary output patterns, in accordance with one embodiment;

FIGS. 12A and 12B illustrate a table and a corresponding binary output pattern, in accordance with one embodiment;

FIGS. 13A and 13B illustrate a table and corresponding binary output patterns, in accordance with one embodiment;

FIG. 14 illustrates a table indicative of stochastic screen data in accordance with one embodiment; and

FIGS. 15A and 15B illustrate a table and corresponding binary output patterns, in accordance with one embodiment.

### DETAILED DESCRIPTION OF THE INVENTION

The particular values and configurations discussed in these non-limiting examples can be varied and are cited merely to illustrate embodiments and are not intended to limit the scope of the invention.

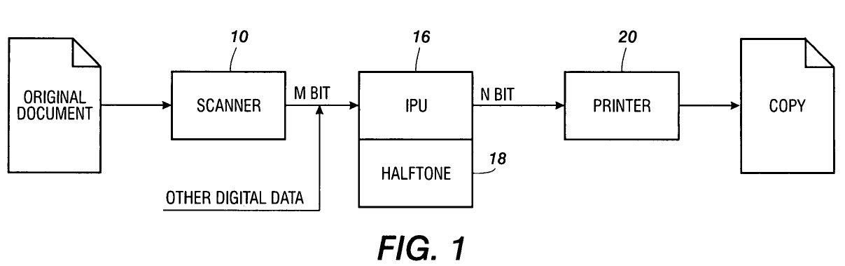

Referring now to the drawings where the showings are for the purpose of describing one or more embodiments and not for limiting the same, a basic image processing system is depicted in FIG. 1. A gray image data can be characterized as image signals, each pixel of which is defined at a single level or optical density in a set of ‘c’ optical density levels, the number of members in the set of levels being larger than desired. Each pixel can be processed in the manner described hereinbelow, to redefine each pixel in terms of a new, smaller set of ‘d’ levels In this process, ‘c’ and ‘d’ are integer values representing pixel depth, or a number of signal levels at which the pixel may appear. One common case of this method includes the conversion of data from a relatively large set of gray levels to one of two legal or allowed binary levels for printing in a binary printer.

As used herein, the term “dot pattern” refers to a product or an image resulting from a screening process. A “screen cell”, as used herein, refers to the set of pixels, which together will form the dot pattern, while the term “screen matrix” will be used to describe the set of values, which together make up the set of threshold to be applied. A “pixel” refers to an image signal associated with a particular position in an image, having a density between white and black. Accordingly, pixels are defined by intensity and position. A dot pattern is made up of a plurality of pixels. These terms are used for simplification and it should be understood that the appropriate sizing operations have to be performed for images where the input resolution in terms of scan pixels is different from the output resolution in terms of print pixels.

In a typical color system, color documents are represented by multiple sets of image signals, each set (or separation) represented by an independent channel, which is usually processed more or less independently. A “color image” as used herein is therefore a document including at least two separations, such as in the Xerox 4850 Highlight Color Printer and commonly three or four separations, such as in the Xerox 4700 Color Laser Printer, Xerox 5775 Digital Color Copier, or the Xerox 4900 printer, or sometimes more than four separations (a process sometimes called hi-fi color).

One possible digital copier (a scanner/printer combination) is described for example, in U.S. Pat. No. 5,014,123, incorporated herein by reference. Each separation provides a set of image signals, which can drive a printer to produce one color of the image. In the case of multicolor printers, the separations superposed together form the color image. In this context, pixels can be described as discrete image signals, which represent optical density of the document image in a given small area thereof. The term “pixel” can be utilized herein to refer to such an image signal in each separation, as distinguished from “color pixel”, which is the sum of the color densities of corresponding pixels in each separation. “Gray”, as used herein does not refer to a color unless specifically identified as such. Rather, the term refers to image signals, which vary between maximum, and minimum, irrespective of the color of the separation in which the signals are used.

With reference now to FIG. 1, which shows a general system requirement representing the goal of the invention, an electronic representation of an original document (hereinafter, an image) from image input terminal such as scanner 10 derives electronic digital data in some manner, in a format related to the physical characteristics of the device, and commonly with pixels defined at m bits per pixel. Common color scanners, such, for example, Xerox 5775 Digital Color Copiers, or the Pixelcraft 7650C, produce 8 bit/pixel data, at resolutions acceptable for many purposes. Since this is a color document, the image is defined with two or more separation bitmaps, usually with identical resolution and pixel depth. The electronic image signals are directed through an image-processing unit (IPU) 16 to be processed so that an image suitable for reproduction on image output terminal or printer 20 is obtained.

Image processing unit 16 commonly includes a halftone processor 18 which converts m bit digital image signals to n bit digital image signals, suitable for driving a particular printer, where m and n are integer values. It also well within the contemplation of the present invention, to derive images electronically. In such cases, a page description language file, describing the appearance of the page, may represent the images. In such a case, the IPU might include processing element for decomposition of the page, and color conversions elements for providing appropriate signals for driving a printer.

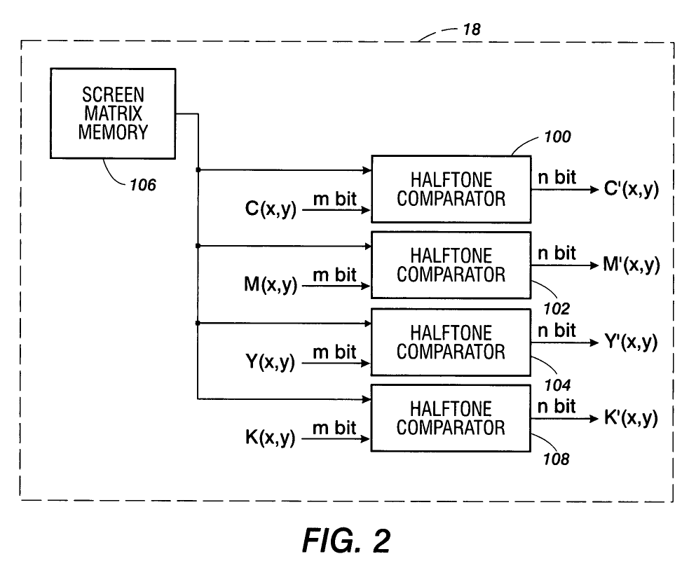

FIG. 2 shows the halftone processor 18 operational characteristics. In this example, there is illustrated a color processing system, using four separations, C(x, y), M(x,y), Y(x, y), K(x, y), obtained and each processed independently for halftoning purposes to reduce an m-bit input to an n-bit output. It will be appreciated that the invention is also applicable to the “single separation” or black and white reproduction situation as well. Accordingly, we show a source of screen matrix information, screen matrix memory 106, which provides one input to each comparator 100, 102, 104, and 108 for each separation, where the other comparator is the m bit separation bitmap. The output is m bit output, which can be directed to a printer. This illustration is highly simplified, in that distinct screen matrices may be supplied to each comparator.

In order to further appreciate the context in which the embodiments disclosed herein can be implemented, consider generating halftone images from constant gray-scale inputs by a screen matrix with N elements. If the overlap between adjacent pixels is ignored, the screen cell with n black pixels and N−n white pixels simulates the input with a gray scale (g) equal to g=(N−n)/N, where 0<n<N, or 0<g<1. The visual appearance of this pattern depends on whether the black pixels or the white pixels are minorities. If the black pixels are, i.e., 0.5<g<1.0, the best visual appearance of the halftone pattern occurs when all black pixels are “evenly” distributed, in other words, each black pixel should “occupy” 1/n, or 1/(1−g)N, fraction of the total area of the screen.

Therefore, the average distance of adjacent black pixels should be equal to α(1−g)^{-1/2}, where α is independent of gray levels. On the other hand, if the white pixels are minorities, i.e., 0<g<0.5, each white pixel should “occupy” 1/(N−m) or 1/gN, fraction of the total area and the average distance of adjacent white pixels should be equal to αg^{1/2}. An idealized stochastic dithering screen is defined as a threshold mask generating halftone images, which satisfy above criterion for all gray levels.

For the following discussion, the input gray-scale images are specified by integer numbers, G(x, y), where 0<G<M. Under this assumption the dithering screen should have M different threshold values spanning from zero to M−1. We further assume that at each level there are (N/M) elements having the same threshold value T. The ultimate goal of designing a stochastic screen is to distribute the threshold values T so that the resulting halftone images are as close as possible to the ones generated by an idealized stochastic screen. Here, it is demonstrated that it is possible to create “good quality” stochastic screens using above criterion and optimization techniques.

Choosing an arbitrary pair of pixels from the dithering screen, we assume that the threshold values for these two pixels are T₁=T(x₁, y₁) and T₂=T(x₂, y₂), respectively, where (x₁, y₁) and (x₂, y₂) are the coordinates of these pixels. As the result of dithering a constant input G, the outputs B₁=B(x₁, y₁) and B₂=B₂(x₂, y₂) have the following possible combinations:

1. B₁=1 and B₂=1, if G>T₁ and G>T₂;

2. B₁=0 and B₂=0, if G<T₁ and G<T₂;

3. B₁≠B₂.

where B=1 represents a white spot and B=0, a black spot for printing Under case 3, where one output pixel is black and another is white, their distance is irrelevant to the visual appearance according to the criterion discussed above. For case 1, we can further consider the difference between the two situations:

1a. if M/2>G, G>T₁, G>T₂;

1b. elsewhere.

Under case 1a, both output pixels are white, and white spots are minorities. Therefore, the corresponding distance between (x₁, y₁) and (x₂, y₂) is relevant to the visual appearance of the halftone images. According to our analysis above this distance is greater or equal to αg^{-1/2}, or a(G/M)^{-1/2}, for outputs of an idealized stochastic screen. Among all G under case 1a, the critical case of G is the smallest one, or G_{c}=Max(T₁, T₂), which requires the largest distance between the two pixels (x₁, y₁) and (x₂, y₂)

Similarly, when both dots appear as black dots, the visual appearance under the following cases must be considered:

2a. if G<M/2; G>T₁ and G>T₂

2b. elsewhere.

Among all G under 2a, the largest G is given by G_{c}=Min(T₁, T₂), which requires the largest distance α(1−G_{c}/M)^{-1/2} between (x₁, y₁) and (x₂, y₂).

Mathematically, we can use a merit function q(T₁, T₂) to evaluate the difference between the idealized stochastic screen and the chosen one. For example, we used the following choice for the experiment described later:
q(T₁, T₂)=exp(−C·d²/d_{c}²), (1)
where
d²=(x₁−x₂)²+(y₁−y₂)²;
d_{c}²=M/[M−Min(T₁, T₂)], if T₂>M/2 and T₁>M/2,
d_{c}²=M/Max(T₁, T₂), if T₂<M/2, and T₁<M/2,
d_{c}²=0, i.e., q=0, elsewhere;

and C is a constant.

Since a dithering screen is used repeatedly for halftoning images larger than the screen, for any chosen pair of pixels from the dithering screen the closest spatial distance in corresponding halftone images depends on the dithering method and should be used for the merit function. The overall merit function should include contributions of all possible combinations. In an experiment the summation of q(T₁, T₂) was for optimization, i.e.,
Q=Σq(T₁, T₂), where Σ for all (x₁, y₁)≠(x₂, y₂) (2)

Now, the design of stochastic screens becomes a typical optimization problem. When the threshold values of a chosen screen are rearranged, the merit function can be evaluated to determine the directions and steps. Many existing optimization techniques can be applied to this approach. The simplest method is to randomly choose a pair of pixels and swap threshold values to see if the overall merit function Q is reduced, since only those q values related to the swapped pair need to be recalculated, the evaluation of Q does not consume significant computation time.

In an example, using the proposed design procedure to produce a screen matrix with 128×64 elements and 256 gray levels was produced. All initial threshold values were randomly chosen by a standard random number generator. Alternatively, the threshold assignments from an existing screen may be used. Besides the Gaussian function described by Equation (1) above as the merit function other functions were tested, such as the Butterworth function and its Fourier transform. Other optimization functions are possible. For this example, Equations (1) and (2) were used as the merit function of optimization. Since this mask is a 45° rotated screen, the 128×64 pattern is repeated with a lateral shift equal to 64. To calculate the overall merit function all pairs of pixels including those with the shift can be considered. A Sun Sparc 10 workstation was used for this design test.

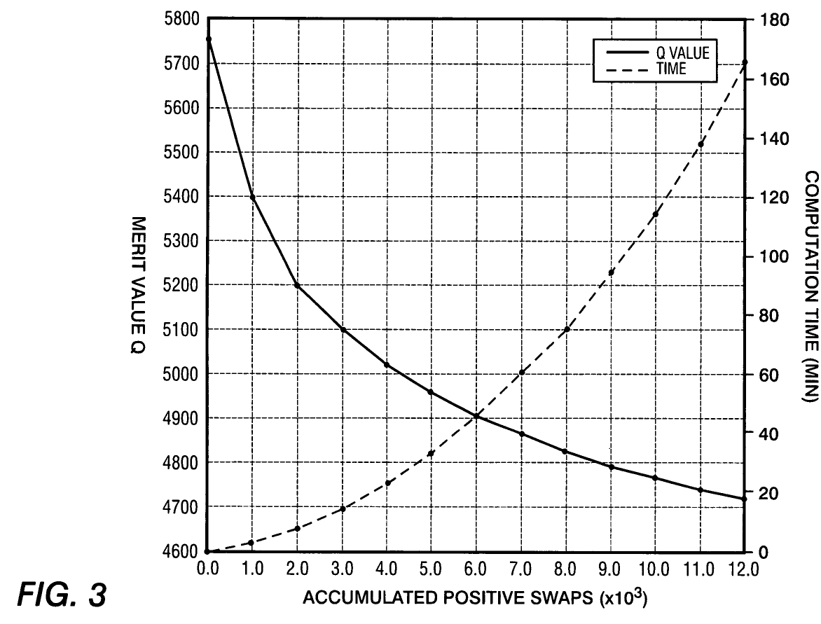

For each iteration a pair of pixels can be randomly selected from the dithering screen, following by swapping their threshold values and calculation of the change of the merit function Q. If Q is not reduced, the threshold values can be restored, otherwise, proceed to the next iteration. In FIG. 3, the merit value Q against the number of accumulated “positive” swaps is shown by the solid lines, while the accumulated computation time in seconds is shown by the dash lines. Increasing the number of swaps tends to improve imaging results from the screens, as the screen matrix becomes more idealized.

It is possible that, depending on the obtained value of the merit function, in some percentage of iterations, the changed threshold values are kept even though they do not improve the merit function Q, a process known as simulated annealing.

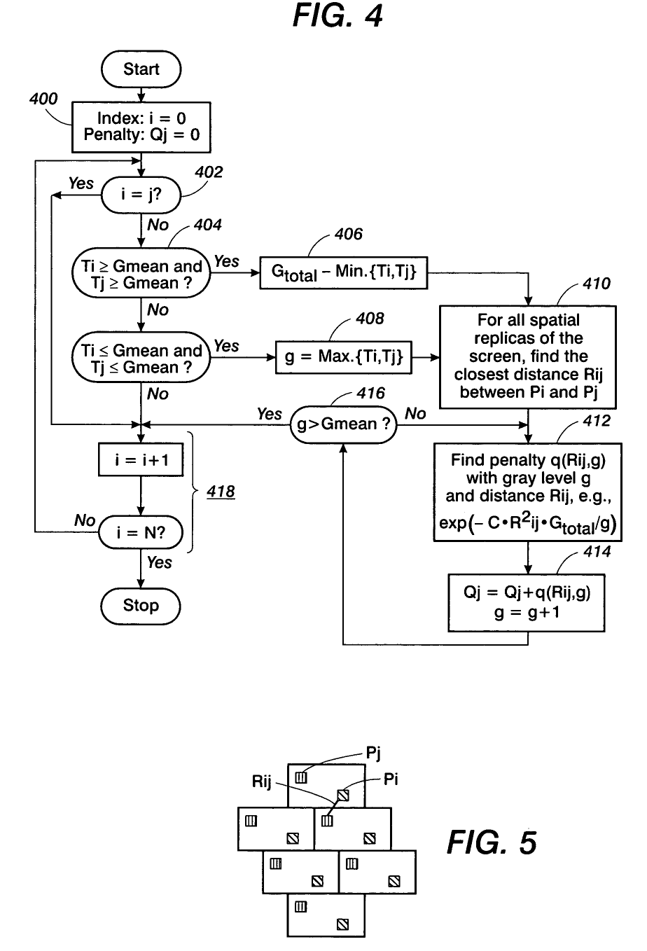

Turning now to FIG. 4 an embodiment can be readily implemented in a general-purpose computer, programmed to generate the screen matrix values. Once obtained, the screen matrix values may be readily entered and stored into a halftoning device memory, such as that shown in FIG. 2. FIG. 4 therefore illustrates a general flow chart of operations depicting logical operational steps that can be practiced for implementing such an embodiment.

One possible embodiment might take the form of a computer programmed in accordance with the methodology illustrated in FIG. 4. For a given pixel Pⱼ, located at xⱼ, yⱼ and with threshold value Tⱼ, we find its contribution Qⱼ to the total penalty function Qₜₒₜₐₗ. All pixels of the given threshold screen with N elements are indexed from 0 to N−1. Each pixel Pᵢ is associated with its index i, the spatial location xᵢ, yᵢ and the threshold value Tᵢ. The mean of the gray scale is Gₘₑₐₙ and the full range of gray scale is Gₜₒₜₐₗ.

As depicted at step 400, index values, including i and Qⱼⱼ are set to 0. Value i refers to the index to all pixels other than Pⱼ, while Qⱼᵢ refers to the total contribution by all pairs of Pⱼ and Pᵢ. As illustrated thereafter at block 402, a operation can be performed in which a counter is checked, while maintaining the calculations when i=j. The operation depicted next at block 404 provides a test wherein each threshold value in the system is compared to the mean gray value for the system, Gₘₑₐₙ. If the threshold values are both greater than Gₘₑₐₙ, g is set to G.ₜₒₜₐₗ−Min{tᵢ, Tⱼ} as indicated by the operation illustrated at block 406. It the threshold values are both less than Gₘₑₐₙ, the value g is set to Max{tᵢ, tⱼ}. In such a case, as indicated by the operation illustrated at block 410, for all the spatial replicas of the screen, we calculate the closest distance Rᵢⱼ between Pᵢ and Pⱼ.

As indicated by the operation illustrated at block 412, using the distance Rᵢⱼ, the penalty value q(Rᵢⱼ, g) can be calculated with gray level g and distance Rᵢⱼ, e.g., exp(-C·R² ij·Gₜₒₜₐₗ/g). The operations depicted at blocks 414 and 416 form an iterative loop with step 412, iteratively calculating Qⱼ=Qⱼ+q(Rᵢⱼ, g) and g=g+1 and determining whether g>Gₘₑₐₙ. If it is not, the penalty value q(Rᵢⱼ, g) at the next gray level is recalculated and added to the total contribution Qⱼ. If g>Gₘₑₐₙ, the value of i is incremented and checked for completion of the iterative process described by blocks 418 and the process is either ended or iterated for the next pixel.

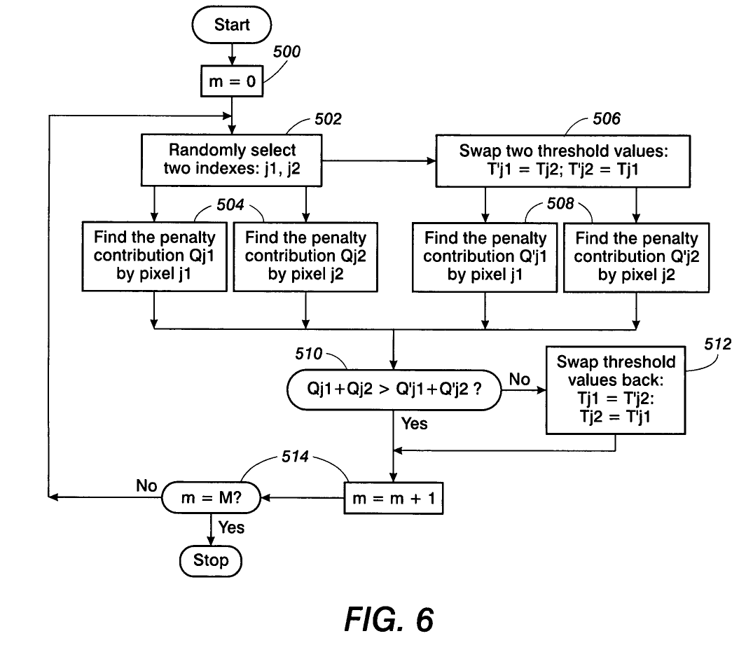

FIG. 5 illustrates the measurement of Rᵢⱼ. FIG. 6, shows a flow chart of a process that optimizes the operation for M iterations. As indicated at block 500, m is set equal to 0. Thereafter, as depicted at block 502, j₁ and j₂ are randomly selected. Based on these values, two processes occur. First, as indicated at block 504, penalty contributions Q₁ and Qⱼ₂ can be calculated for pixel j₁ and j₂ respectively. Second, as indicated at block 506, two corresponding threshold values are swapped so that T′ⱼ₁ is set equal to Tⱼ₂ and T′ⱼ₂ is set equal to Tⱼ₁. As depicted at block 508, from the new values of T′ⱼ₁ and T′ⱼ₂, the penalty contribution Q′ⱼ₁, can be calculated by pixel j₁, and the penalty contribution Q′ⱼ₂, by pixel j2, respectively.

As depicted at block 510 from the calculated penalty values Qⱼ₁, Qⱼ₂, Q′ⱼ₁ and Q′ⱼ₂, it can be determined whether Qⱼ₁+Qⱼ₂>Q′ⱼ₁+Q′ⱼ₂. If not, as illustrated at block 512, T′ⱼ₁ and T′ⱼ₂ can be reset to their original values. Otherwise, the new threshold values are maintained, and as illustrated at block 514, m can be incremented for another iteration and a determination made whether a final iteration has been attained.

Typically speaking, threshold screens can be calculated and stored for later distribution as matrices of threshold values. Upon later distribution, these matrices can be downloaded in an appropriate manner into device memories for use as required. The resulting threshold screens may be used for the generation of gray in monochromatic images. They may also be used for the generation of color separations in polychromatic or other multiple separation images. In polychromatic or color images, these stochastic screens may be used exclusively, or in combination with other stochastic or nonstochastic screens.

FIGS. 1-6 are presented to explain the context in which the embodiments can be practiced. FIGS. 1-6 are generally described herein for general background and edification purposes only and to describe the general implementation of a stochastic screen embodiment. Although most stochastic screens in use have fairly large sizes, usually larger than 100×100 pixels, for illustrative purposes only a very small screen can be described.

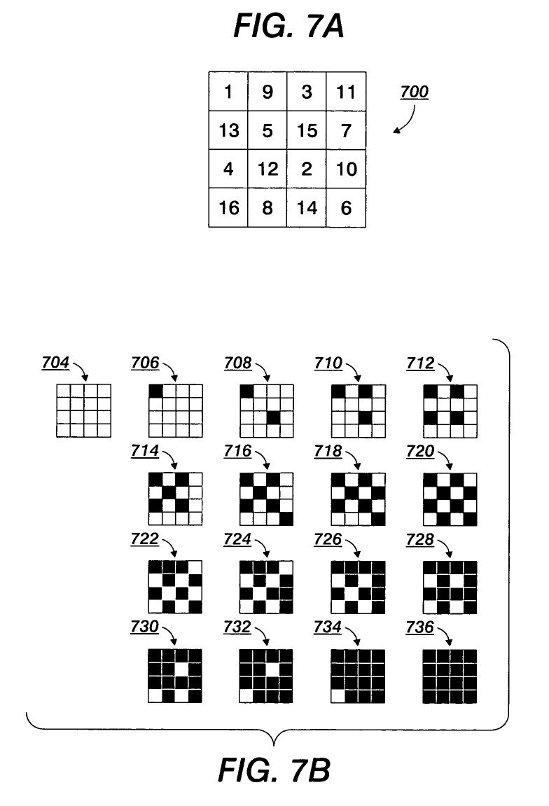

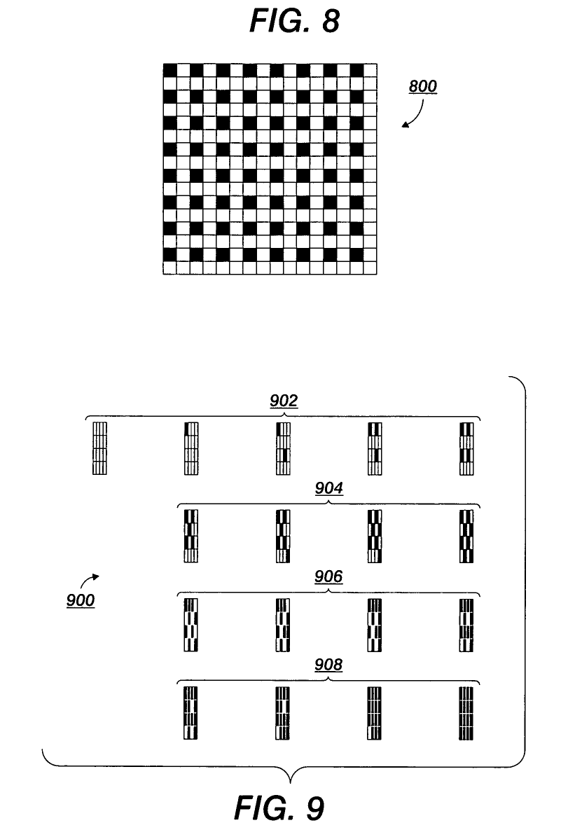

A halftone screen, as an array of threshold values, can be composed of M×N elements. FIG. 7A illustrates a table 700 indicative of a stochastic sequence in the context of a 4×4 array, while FIG. 7B illustrates corresponding output patterns 704-736. With different input values, 0-16, corresponding output binary patterns 704-736 associated with the data indicated in table 700 are respectively illustrated in FIGS. 7A and 7B. Because the halftone process is a “tiling” process, or the screen is used repeatedly when the input image size is greater than the screen size, an example of a larger version of the output binary pattern 800 with an input value of 4 is also provided, as indicated in FIG. 8 for comparison purposes.

Although all of the illustrations depicted herein only indicate binary patterns in the size of one screen, the reader should keep the “tiling feature” in mind to understand the concepts of the embodiments disclosed herein. Thus, for a printer with high addressability (e.g., a Kx high addressability, where K=4 for illustrative purposes), a direct application of the sample screen to a high-addressability print yields a binary output 900 as indicated in FIG. 9 composed of output patterns 902, 904, 906, and 908. From FIGS. 7A, 7B 8, 9, it can be seen that the dot distribution aspect is changed from the original design.

The following embodiments illustrate the process to design a new screen for a printer with Kx high addressability using the compiled M×N isotropic stochastic screen illustrated in table 700 of FIG. 7A as a stochastic dot-growth sequence. The new screen has a size of KM×N elements. For this illustration, K=4, M=4 and N=4, so the new screen has 16×4 elements. Every full pixel consists of four sub-pixels.

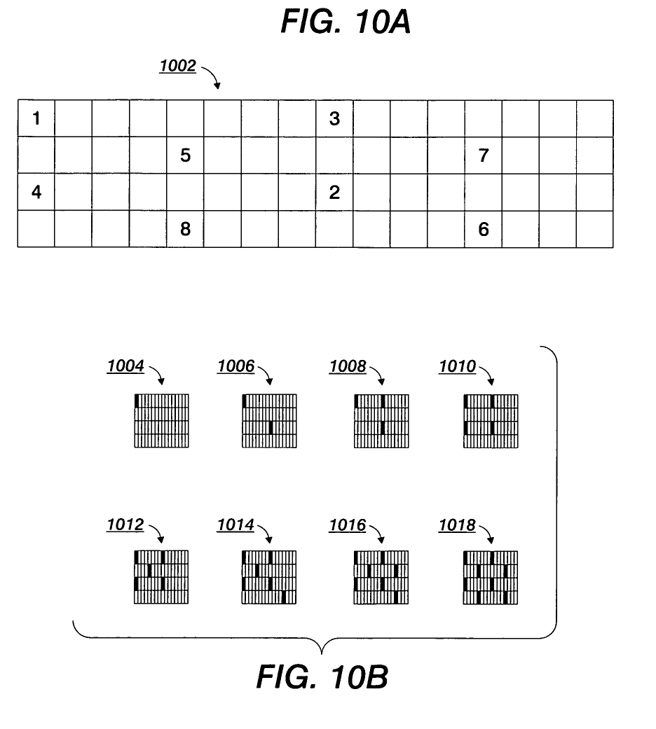

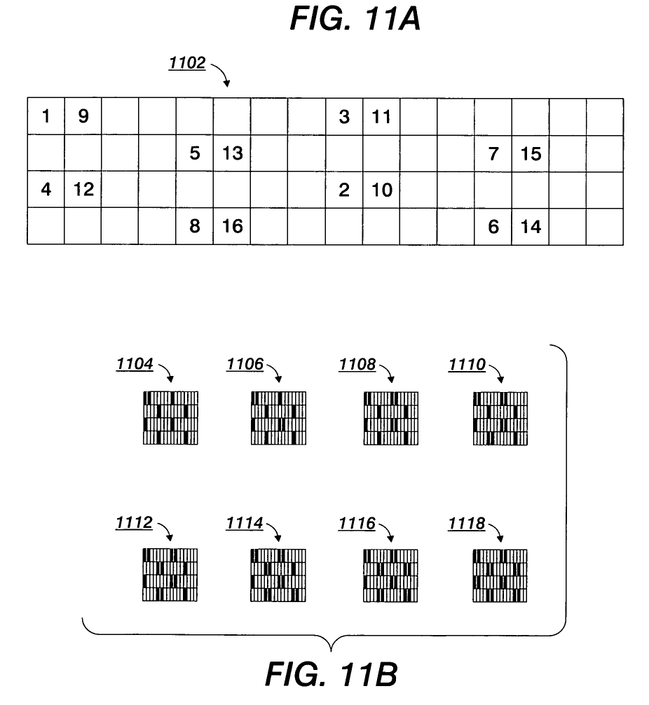

The embodiments can be illustrated in a six-step process as follows. First, the stochastic sequence illustrated in table 700 of FIG. 7A can be divided into two parts: the first part is from 1 to 8; the second part is from 9 to 16. Second, all pixels in the new screen corresponding to the first part of the stochastic sequence in table 700 can be identified. Thereafter, the first part of the stochastic sequence for the first sub-pixel of each full pixel can be utilized in the new screen, as indicated by table 1002 in FIG. 10A. Note that in FIG. 10B, the corresponding binary outputs 1004-1018 corresponding to the inputs from 1-8 of table 1002 are depicted. Third, the same first part of the stochastic sequence in table 700 can be utilized to continue to the second sub-pixels for the new screen, as indicated by table 1102 depicted in FIG. 11A. The corresponding binary outputs 1104-1118 corresponding to the inputs from 9-16 of table 1102 are also depicted in FIG. 11B.

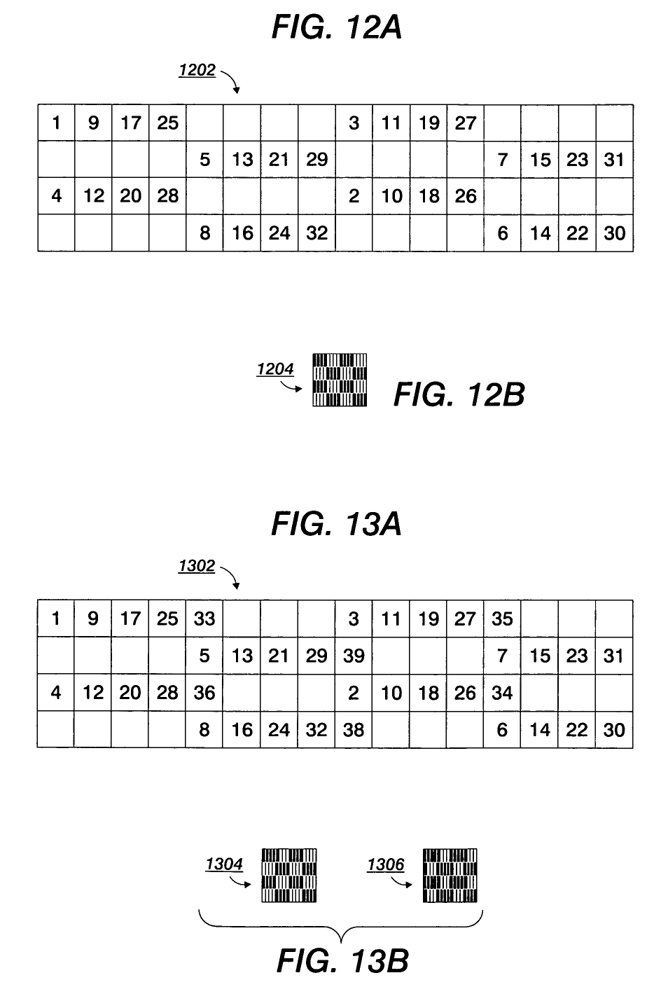

Fourth, the process described above with respect to the third step can continue for the third and fourth sub pixels, with the result indicated by table 1202 depicted in FIG. 12A. The corresponding binary output corresponding to the input 32 appears as the binary output pattern 1204 also depicted in FIG. 12A. Note that FIGS. 12A and 12B are preferably interpreted together.

Fifth, the process continues, wherein a switch is made to the second part of the stochastic screen in order to continue to “fill up” the new screens in a similar manner as described above with respect to the first part of the stochastic sequence. Thus, after assigning the first sub-pixels of the new screen, the data indicated in table 1302 of FIG. 13A are provided, and the corresponding binary outputs 1304, 1306 of FIGS. 13B corresponding to the input 33 and 40 of table 1302 are generated. Note that FIGS. 13A and 13B are preferably interpreted together.

Sixth, continue until threshold values for all subpixels are assigned. The final result of the new screen for the high-addressability printer is depicted in table 1400 of FIG. 14. The stochastic sequence has been used for each step as increment values.

Based on the foregoing, it should be appreciated that there are two possible design variations of note. First, the dividing of original stochastic sequence into two parts is optional. Other options are dividing into more than two parts and conducting the assigning process one by one. So, dividing in two parts as 50-50 is also optional. Depending on the printer characteristics, the dividing line could be chosen other than at 50%.

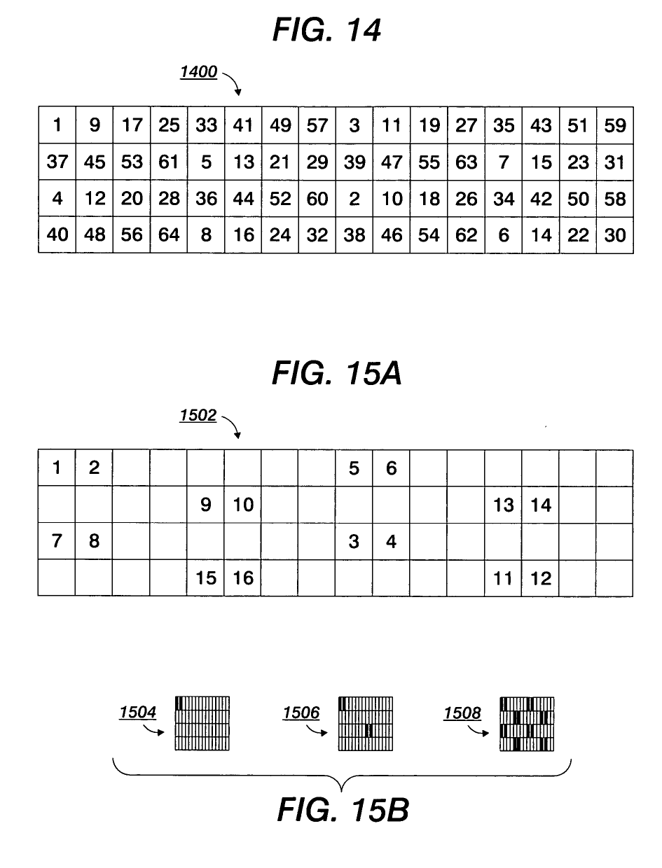

Second, processing one sub-pixel for each step is also optional. Again, depending on the printer characteristics, it is possible to start with two sub-pixels as the first step. For example, after assigning the first 16 values of the new screen, the result appears as indicated in table 1502 of FIG. 15A. The corresponding binary outputs 1504, 1506, and 1508 corresponding to the inputs 2, 4, and 16 of table 1502 are also indicated in FIG. 15B.

The methodology described above can be summarized as follows. Initially, a stochastic dot-growth sequence for a stochastic screen can be complied. The stochastic dot-growth sequence can be then utilized to successively fill a high addressability stochastic screen with a first minimum subpixel. Thereafter, an upper range of said high addressability stochastic screen can be filled with a plurality of varying sequential subpixels, thereby avoiding non-printable subpixel issues and providing improved color stability, smooth transitions, less noise and improved sharpness during rendering via said high addressability stochastic screen.

In general, a stochastic dot-growth sequence for a stochastic screen can be initially compiled into two sections, including at least a first section and at least a second section. Additional sections can be provided as necessary (e.g., third, fourth, etc.). The first section provides, for example, from 0% to 50% area coverage, while the section can provide an area coverage of between 50% and 100% depending upon design considerations. For the first section, the sequential values can be utilized to fill corresponding pixels of a “high addressability” stochastic screen. A similar process is then applied to the second section and additional sections, if necessary.

The stochastic dot-growth sequence can therefore be utilized to successively fill a “high addressability” stochastic screen with a first minimum sub pixel. Thereafter, an upper range of the high addressability stochastic screen can be filled with a plurality of varying sequential sub pixels, thereby avoiding non-printable sub pixel issues and providing improved color stability, smooth transitions, less noise and improved sharpness during rendering via the high addressability stochastic screen.

A standard isotropic stochastic screen can be implemented as, for example, a 1:1 isotropic stochastic screen. The stochastic dot-growth sequence can be initially compiled for the standard isotropic stochastic screen up to 50% coverage thereof. The high addressability stochastic screen itself is generally associated with a rendering device, such as an ink jet printer, which can be implemented as a high-addressability printer.

A stochastic dot-growth sequence can be determined for a normal 1:1 isotropic stochastic screen up to 50% area coverage, for example. Thereafter, the same sequenced can be utilized to successively fill the high addressability screen with a minimum sub pixel (e.g., 2/8^{th} of a full pixel when it is known that ⅛ will not print), and then larger sub pixels until the 1:1 screen is 50% complete. As indicated the upper range (e.g., the second section) can be similarly filled with possibly different sequential sub pixels. The problem of non-printable sub pixels is then avoided.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

The embodiments of the invention in which an exclusive property or right is claimed are defined as follows. Having thus described the invention what is claimed is:

1. A method, comprising:
initially compiling a stochastic dot-growth sequence for a stochastic screen, wherein said stochastic dot-growth screen is divided into at least two sections, including at least a first section and at least a second section thereof, wherein each of said sections comprises a plurality of sequential values;
utilizing said plurality of sequential values of said first section of said stochastic screen to fill corresponding pixels of a high addressability stochastic screen with minimal pixels; and
thereafter applying said plurality of sequential values of said section of said stochastic screen to fill corresponding pixels of said high addressability stochastic screen with a plurality of varying sequential sub pixels, thereby avoiding non-printable sub pixel issues and providing improved color stability, smooth transitions, less noise and improved sharpness during rendering via said high addressability stochastic screen.

2. The method of claim 1 further comprising utilizing said plurality of at least one other section of said stochastic screen to fill corresponding pixels of said high addressability screen in order to avoid non-printable sub pixel issues and providing improved color stability, smooth transitions, less noise and improved sharpness during rendering via said high addressability stochastic screen.

3. The method of claim 1 wherein initially compiling a stochastic dot-growth sequence for an stochastic screen, further comprises:
initially compiling said stochastic dot-growth sequence for said stochastic screen, wherein said stochastic screen comprises an isotropic stochastic screen.

4. The method of claim 1 wherein said first section of said stochastic screen provides an area coverage between 0% and 50%.

5. The method of claim 1 wherein said second section of said stochastic screen provides an area coverage between 50% and 100%.

6. The method of claim 1 wherein said high addressability stochastic screen is associated with a rendering device.

7. The method of claim 1 wherein said high addressability stochastic screen generates an enhanced halftone performance for scanned inputs thereof.

8. The method of claim 1 wherein said scanned inputs comprise textual data.

9. The method of claim 1 wherein said scanned inputs comprise graphic data.

10. A method, comprising:
initially compiling a stochastic dot-growth sequence for a stochastic screen, wherein said stochastic dot-growth screen is divided into at least two sections, including at least a first section and at least a second section thereof, wherein each of said sections comprises a plurality of sequential values;
utilizing said plurality of sequential values of said first section of said stochastic screen to fill corresponding pixels of a high addressability stochastic screen with minimal pixels;
thereafter applying said plurality of sequential values of said section of said stochastic screen to fill corresponding pixels of said high addressability stochastic screen with a plurality of varying sequential sub pixels; and
utilizing said plurality of at least one other section of said stochastic screen to fill corresponding pixels of said high addressability screen in order to avoid non-printable sub pixel issues and providing improved color stability, smooth transitions, less noise and improved sharpness during rendering via said high addressability stochastic screen.

11. The method of claim 9 wherein:
said first section of said stochastic screen provides an area coverage between 0% and 50%; and
said second section of said stochastic screen provides an area coverage between 50% and 100%.

12. The method of claim 10 wherein said high addressability stochastic screen is associated with a rendering device.

13. The method of claim 10 wherein said high addressability stochastic screen generates an enhanced halftone performance for scanned inputs thereof.

14. The method of claim 10 wherein said scanned inputs comprise textual data.

15. The method of claim 10 wherein said scanned inputs comprise graphic data.

16. A system, comprising:
a stochastic dot-growth sequence initially compiled for a stochastic screen, wherein said stochastic dot-growth screen is divided into at least two sections, including at least a first section and at least a second section thereof, wherein each of said sections comprises a plurality of sequential values;
wherein said plurality of sequential values of said first section of said stochastic screen is utilized to fill corresponding pixels of a high addressability stochastic screen with minimal pixels; and
wherein said plurality of sequential values of said section of said stochastic screen is thereafter applied to fill corresponding pixels of said high addressability stochastic screen with a plurality of varying sequential sub pixels, thereby avoiding non-printable sub pixel issues and providing improved color stability, smooth transitions, less noise and improved sharpness during rendering via said high addressability stochastic screen.

17. The system of claim 16 wherein said plurality of at least one other section of said stochastic screen is utilized to fill corresponding pixels of said high addressability screen in order to avoid non-printable sub pixel issues and providing improved color stability, smooth transitions, less noise and improved sharpness during rendering via said high addressability stochastic screen.

18. The system of claim 16 wherein said stochastic screen comprises an isotropic stochastic screen.

19. The system of claim 16 wherein:
said first section of said stochastic screen provides an area coverage between 0% and 50%; and
wherein said second section of said stochastic screen provides an area coverage between 50% and 100%.

20. The system of claim 16 wherein said high addressability stochastic screen generates an enhanced halftone performance for scanned inputs thereof.
